(19) United States
(12) Patent Application Publication
(10) Pub. No.: US 2008/0068164 A1
(43) Pub. Date: Mar. 20, 2008

(54) System and method for sensing and controlling spacing between railroad trains

(75) Inventor: John Richard Campbell, Oldsmar, FL (US)

Correspondence Address: IBM CORPORATION, IPLAW SHCB/40-3, 1701 NORTH STREET, ENDICOTT, NY, 13760, US

(73) Assignee: International Business Machines Corporation, Armonk, NY (US)

(21) Appl. No.: 11/519,273

(22) Filed: Sep. 12, 2006

(51) Int. Cl. G08B 13/14; B61L 27/00; G06G 7/78; B60Q 1/00

(52) U.S. Cl. 340/572.1; 340/425.5; 701/300; 246/2 S

(57) ABSTRACT

System, method and program for sensing and controlling spacing between railroad trains. A first train broadcasts its identity and current time of day to an RFID mounted adjacent to a railroad track approximately when the first train reaches the RFID. In response, the RFID records the identity of the first train and the time of day approximately when the first train reached the RFID. The first train proceeds past the RFID. Subsequently, a second train on the railroad track reaches the RFID and reads from the RFID the identification of the first train and the time of day approximately when the first train reached the RFID. Based on a comparison to the time of day approximately when the first train reached the RFID as read from the RFID to a time of day approximately when the second train reached the RFID, a determination is made as to a time-spacing between the first and second trains. If the time-spacing is below a threshold, an operator of the second train may be alerted.

### FIELD OF THE INVENTION

The present invention relates to electronics and methods for sensing and controlling spacing between railroad trains.

### BACKGROUND OF THE INVENTION

It is common for different railroad trains to utilize the same railroad tracks with spacing between the different railroad trains proceeding in the same direction, based on different schedules for each train. However, often times, trains are late and occasionally, trains are early. This alters the spacing between different trains proceeding in the same direction, as intended by the schedules, and poses some risk of rear-end collision, depending on the scheduled spacing between the trains and the amount of buffer built into the schedule.

A TagMaster (tm of TagMaster.com) system tracks a location of a train as follows. A tag identifying the train is mounted directly on a locomotive or other railroad car, and a reader is mounted on the side of the track. When the train passes the reader, the reader records the identity of the train and the time that it passed. Thus, the TagMaster system provides information as to the location of the train. This information can be used to update passenger information displays at railroad stations and terminals.

An SAIC RailNet Automatic Equipment Identifier System also tracks a location of a train as follows. An Automatic Equipment Identification (“AEI”) reader system identifies rail equipment by reading electronically coded RFID tags mounted to locomotives, railcars, trailers, end-of-train units and intermodal containers. The AEI reader system automatically tracks railcars via the RFID tags, and makes railcar location information available for asset management and other purposes. The RailNet Automatic Equipment Identifier System stores AEI tag data including time, date, train direction and speed.

Active and Passive RFIDs are well known today. Typically, an Active and Passive RFID includes identification or other information about a device to which the RFID is attached. An Active RFID (as well as an RFID reader) has an internal power source, and the ability to broadcast on its own initiative. An Active RFID can broadcast sufficient RF energy to a Passive RFID nearby to power the Passive RFID. The Active RFID can also write data into the Passive RFID for subsequent broadcast by the Passive RFID. A Passive RFID broadcasts its information when the Passive RFID is powered either by an Active RFID or an RFID reader. It is common to attach Passive RFIDs to goods sold in stores as antitheft devices and/or to assist in check-out. It was also known to replace road signs with RFID tags attached to posts and fences, and embedded in road surfaces. A receiver/advice unit in an automobile's dash instrument panel informs the driver of traffic advisory warnings, speed limits, obstacles and other things.

An object of the present invention is to sense and control spacing between railroad trains and delivering this information directly to the operator of the train.

### SUMMARY OF THE INVENTION

The present invention resides in a system, method and program for sensing and controlling spacing between railroad trains. A first train broadcasts its identity and current time of day to an RFID mounted adjacent to a railroad track approximately when the first train reaches the RFID. In response, the RFID records the identity of the first train and the time of day approximately when the first train reached the RFID. The first train proceeds past the RFID. Subsequently, a second train on the railroad track reaches the RFID and reads from the RFID the identification of the first train and the time of day approximately when the first train reached the RFID. Based on a comparison to the time of day approximately when the first train reached the RFID as read from the RFID to a time of day approximately when the second train reached the RFID, a determination is made as to a time-spacing between the first and second trains. If the time-spacing is below a threshold, an operator of the second train may be alerted.

According to other features of the present invention, an RFID mounted in a caboose or other last car of the first train broadcasts the identity of the first train and a current time of day to the RFID mounted adjacent to the railroad track. An RFID mounted in a locomotive in the second train reads from the RFID mounted adjacent to the railroad track the identification of the first train and the time of day approximately when the first train reached the RFID.

### BRIEF DESCRIPTION OF THE FIGURES

FIG. 1 illustrates a system, including an Active RFID in a caboose of a railroad train, an RFID reader and a control program in locomotive of a railroad train and a Passive RFID in or near a railroad track, for sensing and controlling railroad train spacing according to the present invention.

FIG. 2 is a flow chart of processing by the Active RFID and Passive RFID when a leading railroad train reaches the Passive RFID.

FIG. 3 is a flow chart of processing by the RFID reader, control program and Passive RFID sometime later, when a trailing railroad train passes overhead of the Passive RFID.

FIG. 4 is a schematic diagram of the Passive RFID in or near the railroad track of FIG. 1.

FIG. 5 is a schematic diagram of the Active RFID in the caboose of the leading railroad train of FIG. 1.

FIG. 6 is a schematic diagram of the RFID Reader in the locomotive of the trailing railroad train of FIG. 1.

FIG. 7 is a block diagram of a control unit within the system of FIG. 1.

### DETAILED DESCRIPTION OF THE PREFERRED EMBODIMENTS

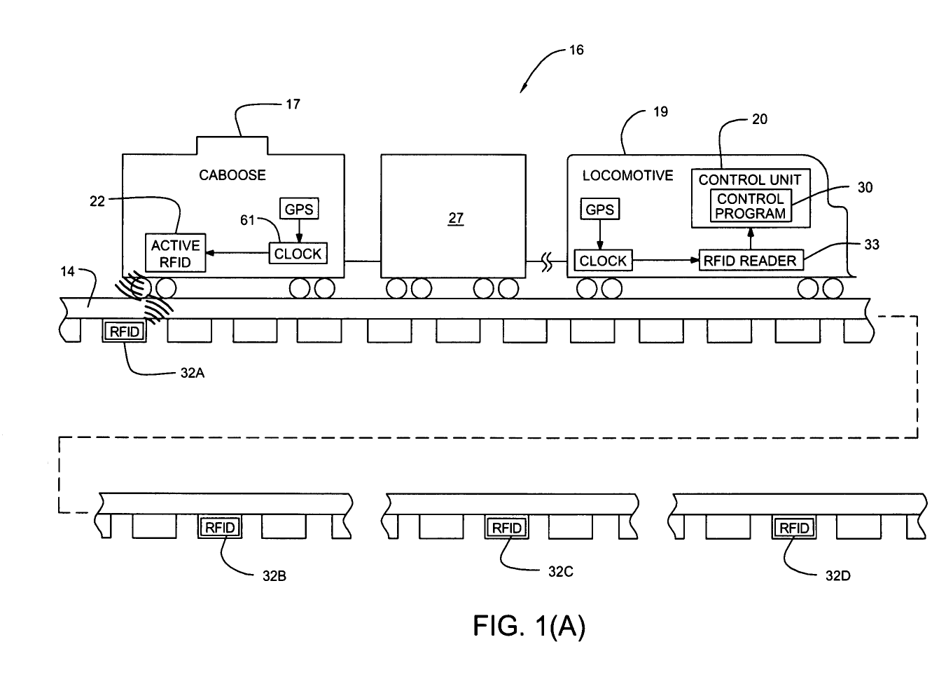

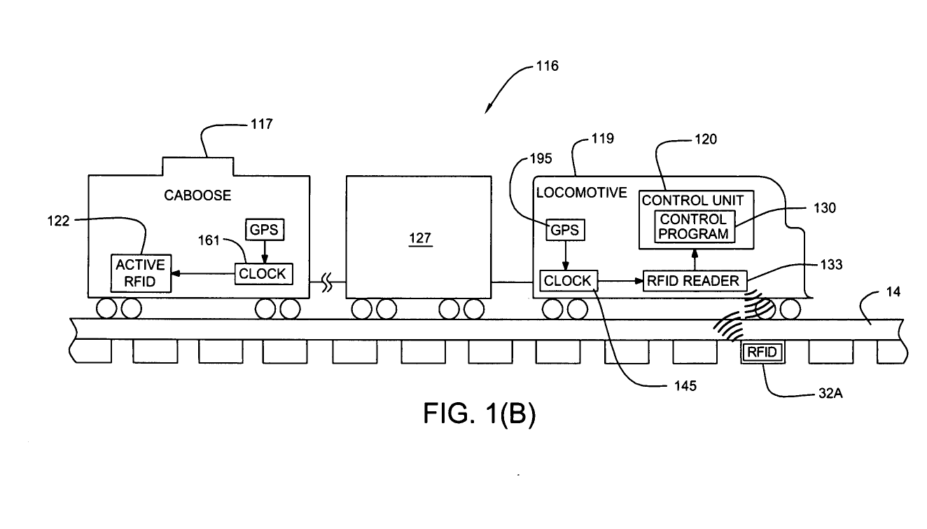

The present invention will now be described in detail with reference to the figures. FIG. 1(a) illustrates a railroad train 16 with a known locomotive 19, caboose 17 and other intermediary railroad cars 27 on a railroad track 14. FIG. 1(b) illustrates another, railroad train 116, behind railroad train 16, with a known locomotive 119, caboose 117 (or other rear car) and other intermediary railroad cars 127 on railroad track 14. FIGS. 1(a) and 1(b) also illustrate a distributed, train spacing control system according to the present invention. The train spacing control system includes an Active RFID 22 mounted in the caboose 17 (or other last car) of railroad train 16, a Passive RFID 32a mounted adjacent to railroad track 14 such as attached to railroad ties or within a housing or fixture adjacent to the railroad track, an Active RFID reader 33 mounted in locomotive 19 of railroad train 16 and a train spacing control unit 20 mounted in locomotive 19.

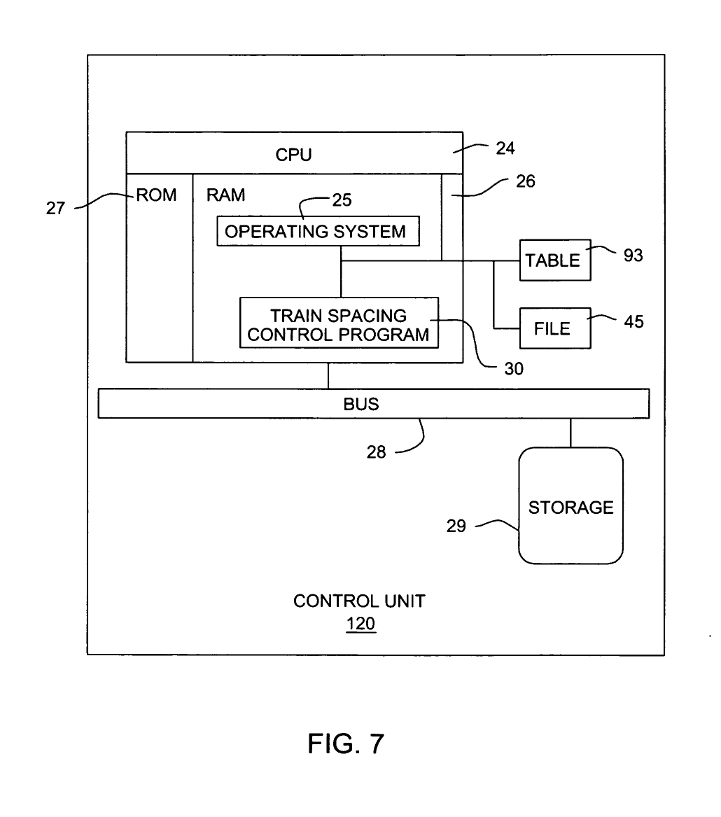

FIG. 7 further illustrates control unit 20 in locomotive 19. Control unit 20 includes a known CPU 24, operating system 25, RAM 26 and ROM 27 on a bus 28, and storage 29. Control unit 20 also includes a train spacing control program 30 according to the present invention. A control unit 120 with a control program 130 in locomotive 119 is similar to control unit 20 and control program 30.

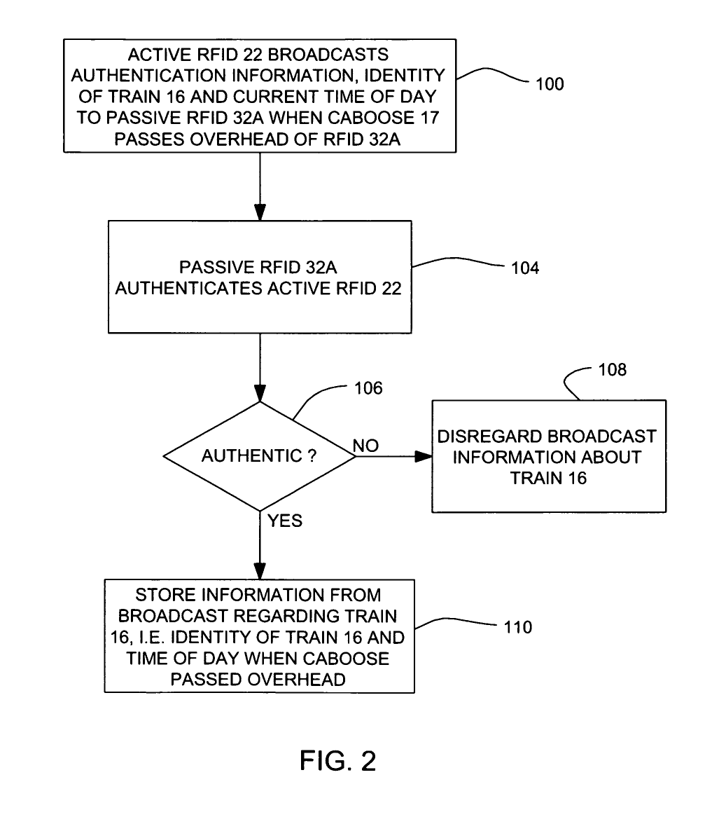

FIG. 2 is a flow chart of processing by Active RFID 22 and Passive RFID 32a within the train spacing control system when caboose 17 passes overhead of Passive RFID 32a. Approximately at that time, Active RFID 22 in caboose 17 broadcasts authentication information (such as an identification of train 16 and a password or other shared secret) for train 16, an identification of train 16 as well as a current time (from a clock 61 or GPS aboard caboose 17) (step 100). Passive RFID 32a receives the broadcast from Active RFID 22 and determines if train 16 is authentic and authorized to broadcast to Passive RFID 32a information regarding train 16 (step 104). An administrator previously entered authentication and authorization information into Passive RFID 32a for train 16, and Passive RFID 32a stored this information in a table 93 in memory. If train 16 is not authentic or authorized (decision 106, no branch), then Passive RFID 32a disregards the rest of the broadcast from Active RFID 22 (or whatever fraudulent device broadcast to Passive RFID 32a) (step 108). However, if train 16 is authentic and authorized (decision 106, yes branch), Passive RFID 32a stores the identification of railroad train 16 and the current time of day (step 110).

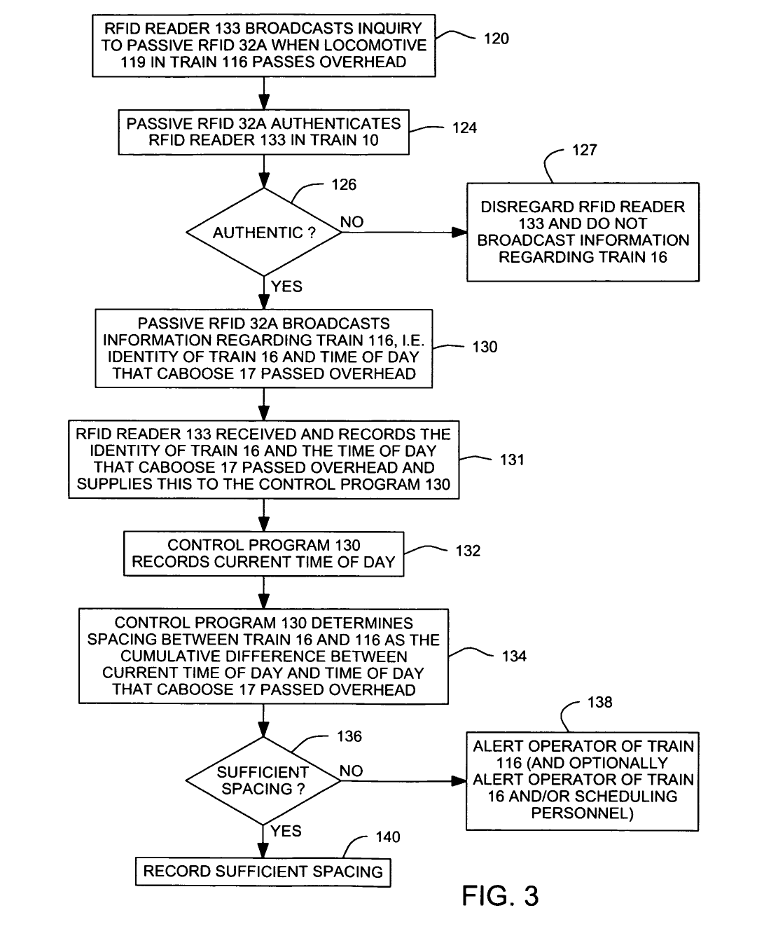

FIG. 3 is a flow chart of processing by control program 130 in control unit 120, RFID Reader 133 and Passive RFID 32a sometime later, when locomotive 119 passes overhead of Passive RFID 32a (and presumably train 16 has further advanced along track 14). When locomotive 119 of railroad train 116 passes over Passive RFID 32a, Active RFID reader/writer 133 broadcasts RF power to Passive RFID 32a as well as authentication information (such as an identification of train 116 and a password or other shared secret) for train 116 (step 120). Passive RFID 32a receives the broadcast from RFID Reader 133 (i.e. RFID 32a becomes activated) and determines if train 116 is authentic and authorized to receive information from Passive RFID 32a regarding train 16 (step 124). An administrator previously entered authentication and authorization information into Passive RFID 32a for train 116, and Passive RFID 32a stored this information in table 93. If train 116 is not authentic or authorized (decision 126, no branch), then Passive RFID 32a disregards RFID Reader 133 and does not broadcast the information regarding train 16, i.e. the identity of train 16 or the time of day it passed over Passive RFID 32a (step 127). However, if train 116 is authentic and authorized (decision 126, yes branch), Passive RFID 32a broadcasts the information it has stored regarding railroad train 16, i.e. passive RFID 32a broadcasts the identification of railroad train 16 and the time of day that caboose 17 of train 16 passed over Passive RFID 32a (and optionally, the geographic location of Passive RFID 32a) (step 130). RFID Reader 133 receives the information regarding train 16 and forwards this information to control program 130 (step 131). In response, control program 130 notes the current time of day (obtained from a clock 195 aboard locomotive 119 (step 132), and compares the current time of day to the time broadcast by Passive RFID 32a (i.e. the time that caboose 17 passed over Passive RFID 32a) to determine how much time has lapsed since caboose 17 passed over Passive RFID 32a, i.e. the time spacing between caboose 17 of train 16 and locomotive 119 of train 116 (step 134). Control program 130 includes in a file 45 an amount of time that should have lapsed since caboose 17 of train 16 passed over Passive RFID 32a, if both trains were on schedule. Control program 130 also includes in file 45 a minimum amount of time that should have lapsed since caboose 17 of train 16 passed over Passive RFID 32a, to assure a safe distance between the end of train 16 and the beginning of train 116 at normal speeds. An administrator previously entered the foregoing information into file 45. If the time lapse is less than a minimum threshold for either the scheduled time-spacing or minimum safe time-spacing (decision 136, no branch), then program 130 notifies a conductor of train 116 to slow down (step 138) and if possible, contact an operator of train 16 or a central station to determine the problem and take corrective action, such as increasing the speed of train 16 or shorten subsequent stops by train 16 to increase the spacing from train 116. If the time-spacing is greater than a minimum threshold for both the scheduled time-spacing or minimum safe time-spacing (decision 136, yes branch), then program 130 records that all is well, and the current time and date (and optionally, the location of Passive RFID 32a) (step 140).

There are various ways that control program 130 can determine the geographic location of Passive RFID 32a, and therefore the location where the time-spacing measurement is made. In one embodiment, an administrator previously programmed into Passive RFID 32a the geographic location of Passive RFID 32a (based on a portable GPS unit deployed during installation of the Passive RFID 32a). In this embodiment, Passive RFID 32a broadcasts to RFID Reader 133 the geographic location of Passive RFID 32a in step 130 so that program 130 knows where the train 116 is located when the information is received from Passive RFID 32a regarding train 16. In a second embodiment, control unit 120 includes a GPS device 195 which supplies current location information to control program 130 so that program 130 knows where the train 116 is located when the information is received from Passive RFID 32a regarding train 16. In a third embodiment, when the conductor receives the notification from control unit 120 in step 138 that the time-spacing is too short, conductor can determine the location of train 116 from visual aids along the railroad track 14 or other knowledge of the train's location, such as which station is next.

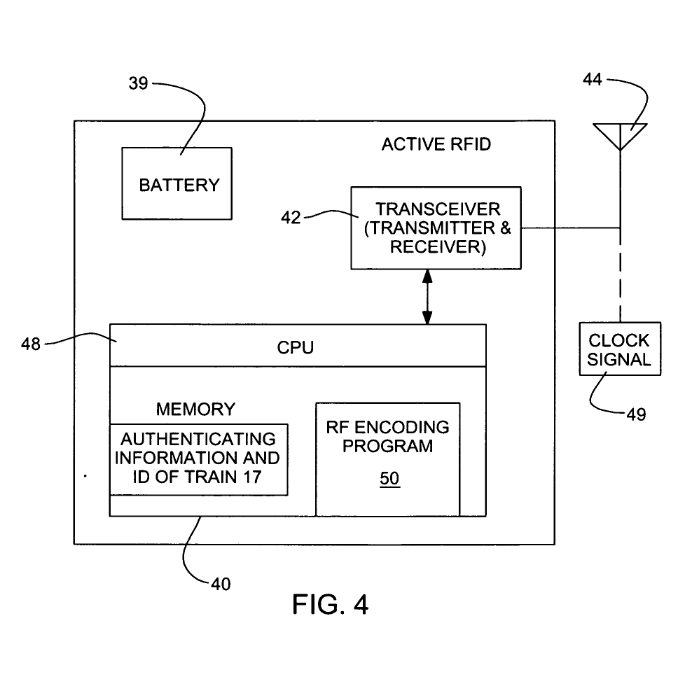

FIG. 4 illustrates Active RFID 22 in more detail. Active RFID 22 comprises a battery 39 (or other inherent power source), CPU 48, random access memory 40 to store the authentication information and identification of train 17, an RF encoding program 50 to supply in a secure manner the authentication information for train 16 and current time of day (and date) to Passive RFID 32a, and a transceiver 42 and antenna 44 to broadcast the authentication information of train 16 and current time of day to Passive RFID 32a. An administrator previously broadcast the authentication information for train 16 and identification of train 16 to Active RFID 22 via antenna 44 and transceiver 42 for storage in memory 40. A clock 61 aboard caboose 17 continuously provides a clock signal 49 indicative of the current time of day (and date) to Active RFID 22.

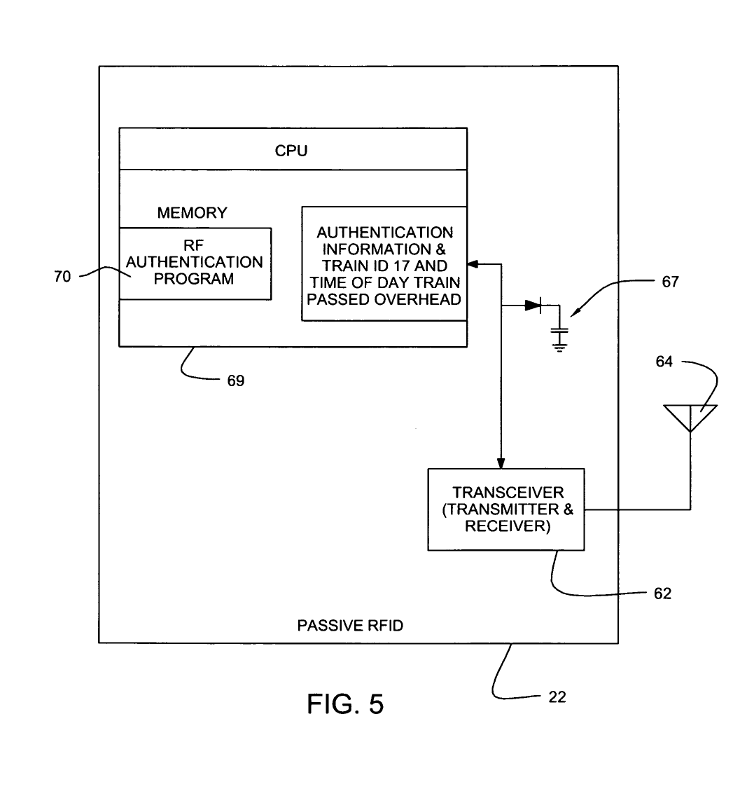

FIG. 5 illustrates Passive RFID 32a in more detail. Passive RFID 32a comprises an antenna 64 and transceiver 62 to receive broadcast from Active RFID 22 to power Passive RFID 32a (by storage of energy in a capacitor 67) and receive the authentication information and identification of train 16 and the current time of day from Active RFID 22. Passive RFID 32a stores the authentication information and identification of train 16 received from Active RFID 22 in memory 69 for comparison to the preprogrammed authentication and authorization information in table 91. Passive RFID 32a also includes an RF authentication program 70 to determine whether Active RFID 22 is authentic and authorized to receive the identification of train 16 and current time of day from Active RFID 22. Passive RFID 32a also stores authentication information for train 116, subsequently receives the authentication information for train 116 from Active RFID 133, and determines if train 116 is authentic and authorized to receive the identity of train 16 and time of day information from train 16.

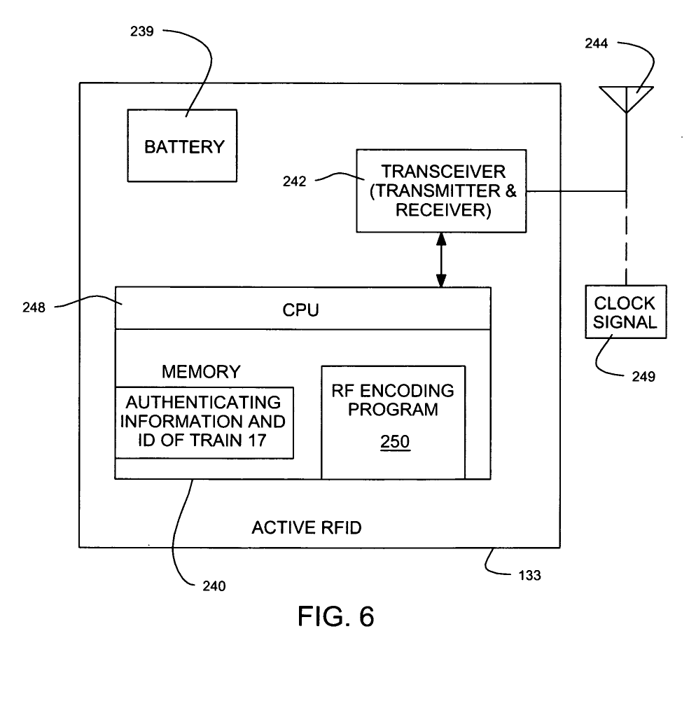

FIG. 6 illustrates Active RFID Reader 133 in more detail. RFID Reader 133 comprises a battery 239 (or other inherent power source), CPU 248, random access memory 240 to store the authentication information and identification of train 116, an RF encoding program 250 to supply the authentication information for train 116 and identification of train 116 to Passive RFID 32a, and a transceiver 242 and antenna 244 to broadcast the authentication information of train 116 and identification of train 116 to Passive RFID 32a. An administrator previously broadcast the authentication information of train 116 and identification of train 116 to RFID 32a via antenna 244 and transceiver 242 for storage in memory 240. A clock 195 aboard locomotive 119 continuously provides a clock signal 249 indicative of the current time of day (and date) to RFID Reader 133. After authentication of train 116 to Passive RFID 32a, Passive RFID 32a broadcasts its stored information regarding train 16, i.e. the identification of train 16 and time of day (and date) that caboose 17 passed overhead Passive RFID 32a. In response, RFID Reader 133 receives and stores this information regarding train 16, and supplies this information to control program 130 in control unit 120 for processing as noted above.

FIG. 1 also illustrates that railroad track 14 includes multiple other Passive RFIDs 32b,c,d, etc. spaced along track 14. The other Passive RFIDs 32b,c,d etc. are identical to Passive RFID 32a; the only difference is their respective locations along railroad track 14. Consequently, as caboose 17 passes over each of the Passive RFIDs 32a,b,c,d etc., Active RFID 22 authenticates itself to each Passive RFID 32a,b,c,d etc. and writes the identification of train 16 and the then current time of day into each Passive RFID 32a,b,c,d, etc. to indicate the successive times that caboose 17 passed over the respective Passive RFIDs. As locomotive 119 subsequently passes over each of the Passive RFIDs 32a,b,c,d etc. and the RFID Reader 133 powers the Passive RFIDs and authenticates itself to each of the Passive RFIDs 32a,b,c,d etc., the Passive RFIDs 32a,b,c,d, etc. broadcast the identification of train 16 and the times that caboose 17 passed over the respective Passive RFIDs 32a,b,c,d, etc. Consequently, RFID reader 133 in locomotive 12 will detect the times that caboose 17 passed over each of the Passive RFIDs 32a,b,c,d, etc. Control program 130 includes in file 45 the locations of Passive RFIDs 32a,b,c,d, etc. or receives from each Passive RFID 32a,b,c,d etc. its geographic location, and therefore can compute the average speed of train 16 between successive Passive RFIDs (based on distance between successive Passive RFIDs divided by time lapse between successive RFIDs) and the time spacing between trains 16 and 116 at each Passive RFID 32a,b,c,d. (An administrator previously entered the foregoing location information into file 45.) Control program 130 will also use the average speed to determine if train 116 is gaining on or falling behind train 16, and therefore whether either train should adjust its speed to obtain or maintain a safe time-spacing, and the minimum safe distance for the current speeds of both trains. Passive RFIDs 32a,b,c,d, etc. can be spaced along the entire railroad track 14, or selective portions of railroad track 14 such as high congestion areas or inside tunnels where radio communication is limited or not available.

Although not shown, caboose 117 in railroad train 116 also includes an Active RFID 122 similar to Active RFID 22, and a locomotive of a railroad train (not shown) behind railroad train 116 includes an RFID reader similar to RFID reader 133 and a train spacing control unit similar to control unit 120, so that the railroad train (not shown) behind railroad train 116 can determine a time-spacing between it and railroad train 116. Likewise, locomotive 19 in railroad train 16 also includes an RFID Reader 33 similar to RFID Reader 133 and a train spacing control unit 20 similar to control unit 120, and a caboose of a railroad train (not shown) ahead of railroad train 16 includes an Active RFID similar to Active RFID 22, so that railroad train 16 can determine a time-spacing between it and the railroad train (not shown) ahead of railroad train 16.

Based on the foregoing, a system and method for sensing and controlling spacing between railroad trains have been disclosed. However, numerous modifications and substitutions can be made without deviating from the scope of the present invention. For example, the control unit may collect “trending” information of the previous train relative to information available locally in order to maintain proper train separation by sensing acceleration and deceleration of the preceding train requiring only accurate clocks on the trains, allowing this system to work within tunnels.

Therefore, the present invention has been disclosed by way of illustration and not limitation, and reference to the following claims should be made to determine the scope of the present invention.

What is claimed:

1. A method for sensing and controlling spacing between railroad trains, said method comprising the steps of:
a first train broadcasting its identity and current time of day to an RFID mounted adjacent to a railroad track approximately when said first train reaches said RFID and in response, said RFID recording said identity of said first train and said time of day approximately when said first train reached said RFID;
said first train proceeding past said RFID;
subsequently, a second train on said railroad track reaching said RFID and reading from said RFID said identification of said first train and said time of day approximately when said first train reached said RFID; and
based on a comparison to said time of day approximately when said first train reached said RFID as read from said RFID to a time of day approximately when said second train reached said RFID, determining a time-spacing between said first and second trains.

2. A method as set forth in claim 1 wherein said time-spacing is below a threshold, and in response, alerting an operator of said second train.

3. A method as set forth in claim 1 wherein the step of said first train broadcasting its identity and current time of day to an RFID is performed by an RFID mounted in a caboose or other last car of said first train.

4. A method as set forth in claim 3 wherein the step of reading from said RFID said identification of said first train and said time of day is performed by an RFID mounted in a locomotive in said second train.

5. A system for sensing and controlling spacing between railroad trains, said system comprising:
a first train including means for broadcasting an identity of said first train and a current time of day to an RFID mounted adjacent to a railroad track approximately when said first train reaches said RFID;
said RFID including means, responsive to said broadcast from said first train, for recording said identity of said first train and said time of day approximately when said first train reached said RFID; and
a second train including means, responsive to said second train arriving on said railroad track adjacent to said RFID, for reading from said RFID said identification of said first train and said time of day approximately when said first train reached said RFID, and based on a comparison to said time of day approximately when said first train reached said RFID as read from said RFID to a time of day approximately when said second train reached said RFID, for determining a time-spacing between said first and second trains.

6. A system as set forth in claim 5 wherein said second train includes means, responsive to said time-spacing being below a threshold, for alerting an operator of said second train.

7. A system as set forth in claim 5 wherein said means within said first train for broadcasting an identity of said first train and a current time of day to an RFID comprises an Active RFID mounted in a caboose or other last car of said first train.

8. A system as set forth in claim 7 wherein said means within said second train for reading from said RFID said identification of said first train and said time of day comprises an Active RFID mounted in a locomotive in said second train.
